(19) United States
(12) Patent Application Publication
(10) Pub. No.: US 2019/0304463 A1
(43) Pub. Date: Oct. 3, 2019

(54) INFORMATION PROVIDING DEVICE, INFORMATION PROVIDING METHOD, AND RECORDING MEDIUM

(71) Applicant: Honda Motor Co.,Ltd., Tokyo (JP)

(72) Inventors: Masaki UEYAMA, Saitama (JP); Tomoyuki SAHATA, Tokyo (JP)

(73) Assignee: Honda Motor Co.,Ltd., Tokyo (JP)

(21) Appl. No.: 16/358,722

(22) Filed: Mar. 20, 2019

(30) Foreign Application Priority Data
Mar. 30, 2018 (JP) 2018-069548

(51) Int. Cl. G10L 15/26; G06F 16/35; G06F 17/27; G10L 15/18

(52) U.S. Cl. CPC G10L 15/265; G06F 16/353; G10L 2015/088; G10L 15/1822; G06F 17/2755

(57) ABSTRACT

An information providing device, an information providing method, and a recording medium capable of assisting in creating user's inspiration and improving efficiency in creating inspiration are provided. The information providing device is an information providing device presenting a first word, and a second word extracted from a second word group, the information providing device including: a second memory unit storing the second word group comprising a plurality of second words corresponding to the first word, and stores the second word group by level of the second words; and a word extraction unit extracting a second word corresponding to the first word from the second word group, wherein the first word is a discussion theme, and a charging system is different for each level in the second word group.

### CROSS-REFERENCE TO RELATED APPLICATION

This application claims the priority benefit of Japan Application No. 2018-069548, filed on Mar. 30, 2018. The entirety of the above-mentioned patent application is hereby incorporated by reference herein and made a part of this specification.

### BACKGROUND

### Technical Field

The disclosure relates to an information providing device, an information providing method, and a recording medium.

### Related Art

Inventors have proposed an idea generation assistance device capable of inspiring a user's idea and leading to a new idea by combining a first word input by the user with a randomly extracted second word and providing the combination to the user in order to recall inspiration (e.g., see Japanese Patent Application No. 2017-157611). Upon recalling inspiration, it is expected that efficient ideas will come out.

In addition, there is known a technique of extracting characteristics relating to a learner's learning based on a result of answers to a test or the like. In a general school's teaching style, a lecturer grasps students' degree of comprehension and so on by a desk patrol around the students. However, in this form, the number of students that one lecturer can check at a time is limited, and it is difficult to accurately and promptly grasp each student's degree of comprehension and so on. Hence, it has been proposed (e.g., see Japanese Laid-open No. 2015-161892 (Patent Document 1)) that in the case where a student has entered an answer to a question in an answer column with an electronic pen system, an analyzer determines the degree of comprehension of the student who entered the answer or a degree of difficulty of the question based on entry information showing the student's handwriting. In the technique described in Patent Document 1, a track from a pen-down in which an electronic pen contacts the answer column until a pen-up in which the electronic pen leaves the answer column is detected as stroke information. In the technique described in Patent Document 1, based on this stroke information, number of strokes per question, answer time, stroke length, area of an entry area within an answer sheet, writing pressure, distance between strokes, direction of entry, distribution of strokes and so on are recognized. Furthermore, in the technique described in Patent Document 1, based on the recognized information, the student's state, such as whether the student is concentrating, stumbling, inspired, or whether group work is going well, is detected. Moreover, in the technique described in Patent Document 1, in the case where a rate of increase in the number of strokes per unit time exceeds a predetermined value, it is determined that the student has an inspiration.

However, with the technique described in Patent Document 1, it is only detecting whether there was an inspiration based on the stroke of the electronic pen, and it is impossible to assist in creating user's inspiration.

The disclosure provides an information providing device, an information providing method, and a program, capable of assisting in creating user's inspiration and improving efficiency in creating inspiration.

### SUMMARY

(1) An information providing device (1) according to an aspect of the disclosure is an information providing device presenting a first word, and a second word extracted from a second word group, the information providing device including: a second memory unit (103) storing the second word group comprising a plurality of words corresponding to the first word, and storing the second word group by level of the words; and a word extraction unit (second word extraction unit 104) extracting a word corresponding to the first word from the second word group as the second word, wherein the first word is a discussion theme, and a charging system is different for each level in the second word group.

(2) An information providing method according to an aspect of the disclosure is an information providing method in an information providing device. The information providing device has a second memory unit that stores a second word group comprising a plurality of words corresponding to a first word, a charging system being different for each level of the words in the second word group, and that stores the second word group by the level of the words. The information providing method includes: a step (step S1) in which the information providing device sets the first word being a discussion theme; a step (step S2) in which the information providing device presents the level and sets a second word to a level selected from among the presented level; a word extracting step (step S4) in which the information providing device extracts a word corresponding to the first word from the second word group as the second word; a presentation step (step S5) in which the information providing device presents the first word and the second word; and a charging step (steps S3, S6 and S8) in which the information providing device calculates a usage charge based on the level and at least one of view count and view time of the presentation and performs charging.

(3) A non-transitory recording medium according to an aspect of the disclosure stores a program for a computer of an information providing device. The information providing device has a second memory unit that stores a second word group comprising a plurality of words corresponding to a first word, a charging system being different for each level of the words in the second word group, and that stores the second word group by the level of the words. The program causes the computer to execute: a step of setting the first word as a discussion theme; a step of presenting the level and setting a second word to a level selected from among the presented level; a word extracting step of extracting a word corresponding to the first word from the second word group as the second word; a presentation step of presenting the first word and the second word; and a charging step of calculating a usage charge based on the level and at least one of view count and view time of the presentation and performing charging.

### BRIEF DESCRIPTION OF THE DRAWINGS

FIG. 1 illustrates a configuration example of an information providing device according to the present embodiment.

FIG. 2 illustrates an example of information stored in a second memory unit according to the present embodiment.

FIG. 3 illustrates an example of a word of a first word group and a second word group according to the present embodiment.

FIG. 4 illustrates an example of an image displayed on a display unit at the start of use of the information providing device according to the present embodiment.

FIG. 5 illustrates an example of a first word and a second word presented on the display unit during the use of the information providing device according to the present embodiment.

FIG. 6 is a flowchart showing an example of a processing procedure performed by the information providing device according to the present embodiment.

FIG. 7 is a block view showing a configuration example of an information providing device in a first modification of the present embodiment.

FIG. 8 is a block view showing a configuration example of an information providing device in a second modification of the present embodiment.

FIG. 9 is a block view showing a configuration example of an information providing system in a third modification of the present embodiment.

FIG. 10 illustrates an example of a Web application providing method in the third modification.

### DESCRIPTION OF THE EMBODIMENTS

(4) In the information providing device according to an aspect of the disclosure, the level of the words may be a number of times the words have been extracted by the word extraction unit in the past.

(5) In the information providing device according to an aspect of the disclosure, the second word may be preset by a predetermined professional.

(6) In the information providing device according to an aspect of the disclosure, the information providing device may be operated by an application, and may perform charging based on the level and according to an operation condition of the application.

(7) In the information providing device according to an aspect of the disclosure, the operation condition may include at least one of view count and view time.

(8) In the information providing device according to an aspect of the disclosure, the application may be operated on the Web.

(9) In the information providing device according to an aspect of the disclosure, the application may be provided by a recording medium.

(10) In the information providing device according to an aspect of the disclosure, a first memory unit (101) storing a first word group comprising at least one word and storing a word group of a discussion theme in the first word group, and a first word extraction unit (first word extraction unit 102) extracting a word from the first word group as the first word are further included. The information providing device may present the level before extracting the second word and set the second word to a level selected from among the presented level, and may present the first word extracted by the first word extraction unit, and the second word extracted from among the second word group of the set level by the word extraction unit.

According to the above (1), (2) or (3), since the first word and the second word corresponding to the first word and corresponding to the level can be provided, it is possible to assist in creating user's inspiration and improve efficiency in creating inspiration.

According to the above (4), since the words of the second word group are stored for level based on the number of times of being extracted, it is possible to make the words to be recalled different depending on the level to be used.

According to the above (5), a suitable second word corresponding to the first word can be provided.

According to the above (6) or (7), charging can be performed according to the user's use condition.

According to the above (8), the user can also use this service from a smartphone or a tablet terminal or the like. Also, according to (8), since there is no need to store the second word group or the application, execution is possible even if memory capacity of the device is small.

According to the above (9), the user can use the latest application.

According to the above (10), the first word being a theme discussed by the user can be extracted according to circumstances.

Hereinafter, an embodiment of the disclosure is explained with reference to the drawings.

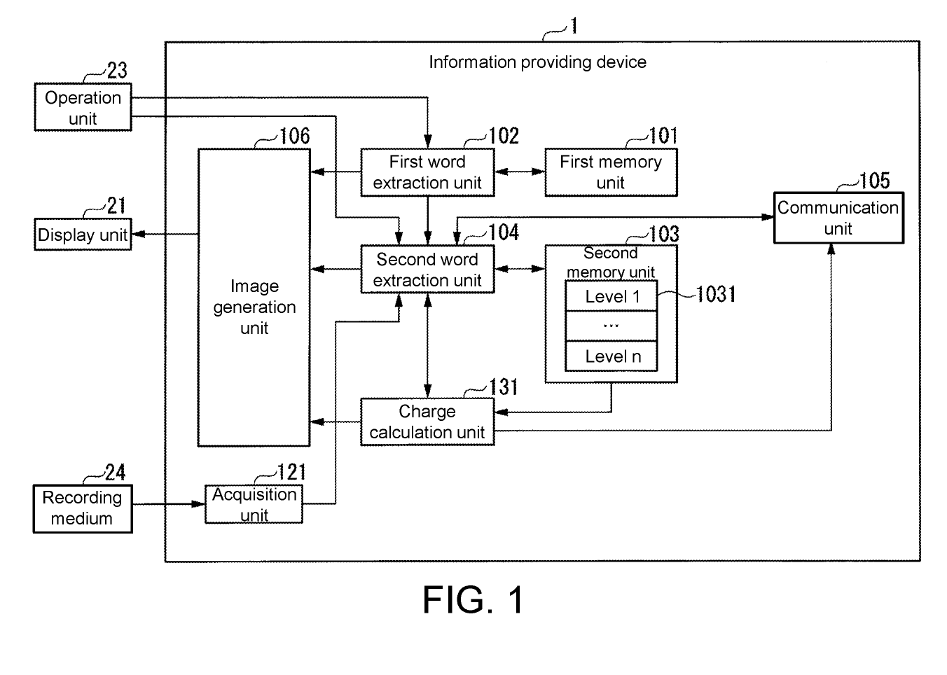

FIG. 1 illustrates a configuration example of an information providing device 1 according to the present embodiment.

As shown in FIG. 1, the information providing device 1 includes a first memory unit 101, a first word extraction unit 102 (first word extraction unit), a second memory unit 103, a second word extraction unit 104 (word extraction unit), a communication unit 105, an image generation unit 106, an acquisition unit 121, and a charge calculation unit 131.

A display unit 21 and an operation unit 23 are connected to the information providing device 1. In addition, the information providing device 1 acquires information from a recording medium 24.

The display unit 21 is a liquid crystal display device, an organic electroluminescence (EL) display device, an electronic ink display device, or the like. The display unit 21 displays an image output by the image generation unit 106.

The operation unit 23 is a keyboard, a mouse, a tablet, a touch panel sensor, or the like. The operation unit 23 detects an operation result of a user's operation, and outputs the detected operation result to the first word extraction unit 102. The operation unit 23 detects an operation result of the user's operation, and outputs the detected operation result to the second word extraction unit 104. The operation unit 23 may be connected to the information providing device 1 via a wireless network. In this case, the operation unit 23 may be a tablet terminal, a smartphone or the like. The user operates the operation unit 23 to input a word of a first word group. The user operates the operation unit 23 to select a level used by a second word group.

The recording medium 24 is, for example, any one of a universal serial bus (USB) memory, a memory card, an optical disk, a magnetic disk, and a magnetic tape. In the recording medium 24, the second word group comprising a plurality of words are stored for each word of a first word group.

The first memory unit 101 stores the first word group comprising at least one word. The word stored in the first memory unit 101 is, for example, a discussion theme. The first memory unit 101 may be placed on a cloud. In addition, in the case where the first memory unit 101 stores a plurality of words, the first memory unit 101 may store each word in association with an order or priority order of discussion, or date and time when the discussion is conducted and so on.

The first word extraction unit 102 acquires a word based on the detection result output by the operation unit 23, and outputs the acquired word as a first word to the image generation unit 106. The first word extraction unit 102 may also store the acquired word in the first memory unit 101. Alternatively, the first word extraction unit 102 may extract one word as the first word from the first word group stored in the first memory unit 101, and output the extracted first word to the second word extraction unit 104 and the image generation unit 106. The first word extraction unit 102 may store a plurality of words in the first memory unit 101 in advance and randomly extract one word during discussion, or may extract a discussion theme for that day according to the user's instruction. Accordingly, according to the present embodiment, the first word being the theme discussed by the user can be extracted according to circumstances.

The second memory unit 103 stores the second word group comprising a plurality of words. The second memory unit 103 stores the words by level as shown by a sign 1031. Moreover, the level refers to the level of the words of the second word group and is set based on, for example, a number of times the words have been extracted by the second word extraction unit 104. For example, the word that has been extracted the greatest number of times is assigned level 1, and the word that has been extracted the smallest number of times is assigned level 4. In the case where there are a plurality of words in the first word group, the second memory unit 103 stores the second word group for each word of the first word group. The information stored in the second memory unit 103 will be described later. The second memory unit 103 may be placed on a cloud.

The second word extraction unit 104 acquires the first word output by the first word extraction unit 102. The second word extraction unit 104 selects a level based on the operation result output by the operation unit 23. The second word extraction unit 104 outputs information indicating the selected level to the charge calculation unit 131. The second word extraction unit 104 selects one word corresponding to the acquired first word from the selected level of the second word group stored in the second memory unit 103 as a second word, and outputs the extracted second word to the image generation unit 106.

The second word extraction unit 104 may search and acquire a plurality of words corresponding to the acquired first word from, for example, the Internet, via the communication unit 105, and store the acquired words in the second memory unit 103. For example, the second word extraction unit 104 searches for the first word using an Internet search engine and acquires the words.

The second word extraction unit 104 may acquire the second word group output by the acquisition unit 121 and stored in the recording medium 24, and may store the acquired second word group in the second memory unit 103.

The communication unit 105 is a wireless communication unit or a wired communication unit. The communication unit 105 connects to a network according to an instruction from the second word extraction unit 104. The communication unit 105 acquires the searched word and outputs the acquired word to the second word extraction unit 104. The communication unit 105 sends, to an external device (e.g., a charge counting system, etc.) via the network, information output by the charge calculation unit 131 and indicating a usage charge.

The image generation unit 106 generates the first word output by the first word extraction unit 102 and the second word output by the second word extraction unit 104 as one image and outputs the image to the display unit 21. The image output to the display unit 21 includes a text image of the first word and a text image of the second word. The image generation unit 106 outputs to the display unit 21 an image of the usage charge of the information providing device 1 that is output by the charge calculation unit 131.

The acquisition unit 121 acquires the information recorded on the recording medium 24 and outputs the acquired information to the second word extraction unit 104. The acquisition unit 121 includes a USB terminal when the recording medium 24 is a USB memory; the acquisition unit 121 includes a memory card reader when the recording medium 24 is a memory card; the acquisition unit 121 includes an optical disk reader when the recording medium 24 is an optical disk; the acquisition unit 121 includes a magnetic disk reader when the recording medium 24 is a magnetic disk.

The charge calculation unit 131 calculates the usage charge of the information providing device 1 based on the information output by the second word extraction unit 104 that indicates the level, and a charge stored in the second memory unit 103. The charge calculation unit 131 outputs the calculated usage charge to the image generation unit 106. Alternatively, the charge calculation unit 131 sends the calculated usage charge to an external device (not illustrated) via the communication unit 105. Herein, the external device is, for example, a personal computer, a smartphone or a tablet terminal used by the user.

Next, an example of the information stored in the second memory unit 103 is explained.

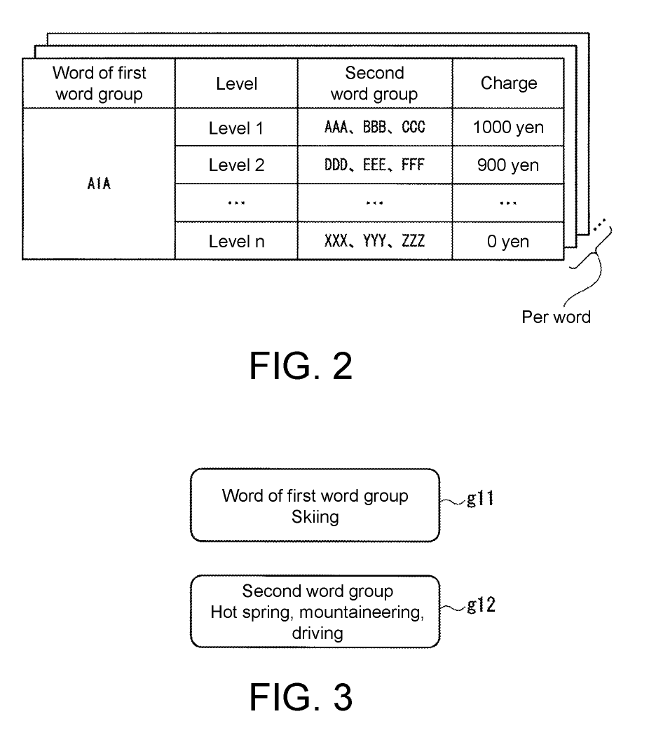

FIG. 2 illustrates an example of the information stored in the second memory unit 103 according to the present embodiment.

As shown in FIG. 2, the second memory unit 103 stores the second word group by level and the charge in association with the word of the first word group. In addition, the second memory unit 103 stores this information for each word of the first word group.

The second word group includes at least one word. In the example shown in FIG. 2, the second word group is classified into level 1 to level n (n is an integer of 1 or greater). The second word group of level 1 includes words “AAA”, “BBB” and “CCC”. Moreover, in the example shown in FIG. 2, level 1 denotes the words having the highest frequency of use, level 2 denotes the words having a lower frequency of use than the words of level 1 and a higher frequency of use than the words of level 3, and level n denotes the words having the lowest frequency of use. In the present embodiment, a charge is set for each of these levels. In the example shown in FIG. 2, the charge for level 1 is 1000 yen, the charge for level 2 is 900 yen and the charge for level n is 0 yen. It is also possible to obtain an idea unexpected by the user from the words having a lower frequency of use. Hence, the lower frequency of use may be denoted by level 1 and the higher frequency of use may be denoted by level 4.

Moreover, in the classification by level, the level or charge is set based on frequency of selection as the second word corresponding to the first word. Alternatively, in the classification by level, the level or charge is set based on the good or bad of a conclusion drawn by the user as a result of selection and presentation as the second word corresponding to the first word. Whether the conclusion is good or bad may be evaluated by, for example, the user themselves.

Next, an example of the word of the first word group and the second word group is explained.

FIG. 3 illustrates an example of the word of the first word group and the second word group according to the present embodiment. A sign g11 indicates an example of the word of the first word group. A sign g12 indicates an example of the second word group.

The word of the first word group is a word (set word) set by the user. In the example shown in FIG. 3, the word of the first word group is “skiing”. The word of the first word group is, for example, input by the user operating the operation unit 23. Alternatively, when the information providing device 1 is used, at least one word of the first word group is stored as the first word group in the first memory unit 101.

The words of the second word group correspond to the first word. In the example shown in FIG. 3, the second word group is “hot spring, mountaineering, driving”. The words of the second word group are information acquired from the recording medium 24 or acquired via the communication unit 105 and stored in the second memory unit 103. After at least one second word group is stored in the second memory unit 103, use of the information providing device 1 is started.

The words of the second word group may be on the top of a search result obtained by using, for example, a search engine, to search the word of the first word group on the Internet via the communication unit 105.

In addition, the words of the second word group may be preset by a predetermined professional. In the case where the word is, for example, skiing, the predetermined professional may refer to an owner of a pension or hotel for ski racers and skiers, or a member of a travel agency or advertising agency.

Next, an example of an image displayed on the display unit 21 during the use of the information providing device 1 is explained.

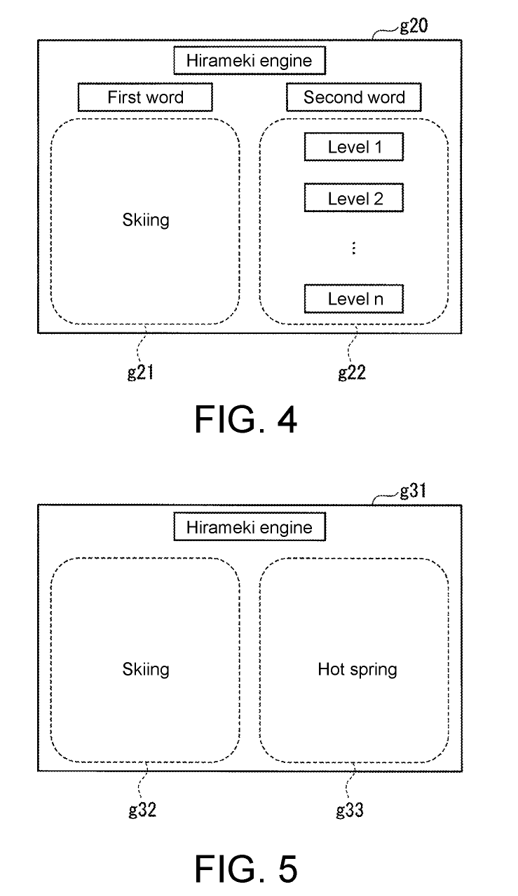

FIG. 4 illustrates an example of an image g20 displayed on the display unit 21 at the start of use of the information providing device 1 according to the present embodiment.

A sign g20 indicates an example of an image displayed on the display unit 21. At the start of use, the first word (sign g21) and an image g22 of selection of the level of the second word to be used are displayed on the display unit 21.

The user operates the operation unit 23 to select the level. Based on a result of operation of the operation unit 23, the information providing device 1 selects one second word corresponding to the first word from the second word group of the level.

Moreover, the information providing device 1 may also display the charge for each level in association with the image of selection of the level.

FIG. 5 illustrates an example of the first word and the second word presented on the display unit 21 during the use of the information providing device 1 according to the present embodiment.

A sign g31 indicates an image displayed on the display unit 21. A sign g32 indicates an image of the first word. A sign g33 indicates an image of the second word. The display on the display unit 21 is an example and the disclosure is not limited thereto. For example, in the case where the first word is a discussion theme, the information providing device 1 may further display an image of the characters “discussion theme” in the image of the sign g31.

In the example shown in FIG. 5, the information providing device 1 extracts or sets “skiing” as the first word, extracts “hot spring” as the second word corresponding to the first word, and presents the first word and the second word.

The presentation example of the first word and the second word shown in FIG. 5 is an example and the disclosure is not limited thereto. The information providing device 1 may present the first word and the second word by arranging them vertically side by side, or may present them together with colors corresponding to each word as described in Japanese Patent Application No. 2017-157611, or may present each word by animation as described in Japanese Patent Application No. 2017-157611.

The user looks at the two words “skiing” and “hot spring” presented in this way and recalls a new word from these two words. It is assumed the words that the user recalls include, for example, “Zao”, “party”, “night game” and so on.

In this way, the user uses the information providing device 1 when recalling a new word from two presented words. At the start of use of the information providing device 1, the user, for example, selects a desired level from which the second word corresponding to the first word being a discussion theme is to be selected.

Next, an example of a processing procedure performed by the information providing device 1 is explained.

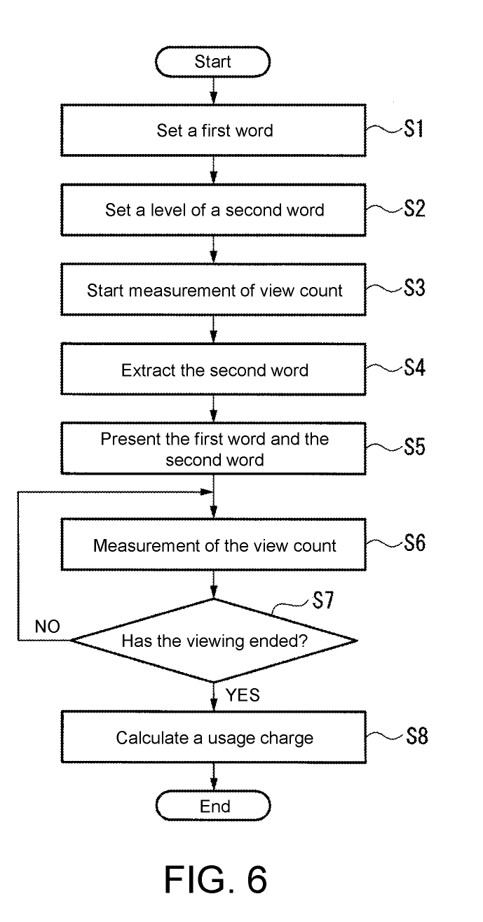

FIG. 6 is a flowchart showing an example of a processing procedure performed by the information providing device 1 according to the present embodiment.

(Step S1) The user operates the operation unit 23 to set the first word. Alternatively, the first word extraction unit 102 extracts one word from the first word group stored in the first memory unit 101 as the first word.

(Step S2) The user operates the operation unit 23 to select a level. The second word extraction unit 104 sets the level based on an operation result of the operation unit 23.

(Step S3) The charge calculation unit 131 starts measurement of view count.

(Step S4) One word corresponding to the acquired first word is extracted from the selected level of the second word group stored in the second memory unit 103 as the second word.

(Step S5) The information providing device 1 presents the first word and the second word.

(Step S6) The charge calculation unit 131 measures the view count.

(Step S7) The charge calculation unit 131 discriminates whether or not viewing of the user has ended. In the case where the charge calculation unit 131 discriminates that the viewing has ended (step S7: YES), the processing proceeds to step S8; in the case where the charge calculation unit 131 discriminates that the viewing has not ended (step S7: NO), the processing returns to step S6.

(Step S8) The charge calculation unit 131 calculates a usage charge based on the view count and a charge set for the level. For example, the charge calculation unit 131 calculates the usage charge by multiplying the (view count) by the (charge set for the level).

Then, the information providing device 1 ends the processing.

In order to detect whether or not a word is recalled by two presented words, the charge calculation unit 131, for example, counts each time input is performed by the operation unit 23 when the user recalls the word.

An example of calculating the usage charge by measuring the view count has been explained in FIG. 6, but the disclosure is not limited thereto. The charge calculation unit 131 may also measure view time and calculate the usage charge by multiplying the (view time) by the (charge set for the level).

In addition, in the processing in FIG. 6, the view count may be measured each time when one word is recalled after the first word and the second word are presented. Then, the charge calculation unit 131 calculates the usage charge based on the level and at least one of the view count and the view time and performs charging.

As described above, in the present embodiment, the second word corresponding to the first word being a discussion theme may be classified into levels and stored. In addition, in the present embodiment, the charge may be set for each level.

Accordingly, according to the present embodiment, the user can look at the charge for the level and select which level of the second word to use. For example, in the case where the discussion theme is an important theme, the user selects level 1 even if the charge is high; in the case where the discussion theme is not very important, the user can select a level with a lower charge. As a result, according to the present embodiment, it is possible to assist in creating user's inspiration and improve efficiency in creating inspiration.

### <First Modification>

In order to detect whether or not a word is recalled by two presented words, the number of times the word is recalled may be counted by carrying out dependency analysis or the like by performing voice recognition on the user's utterance when the user recalls the word.

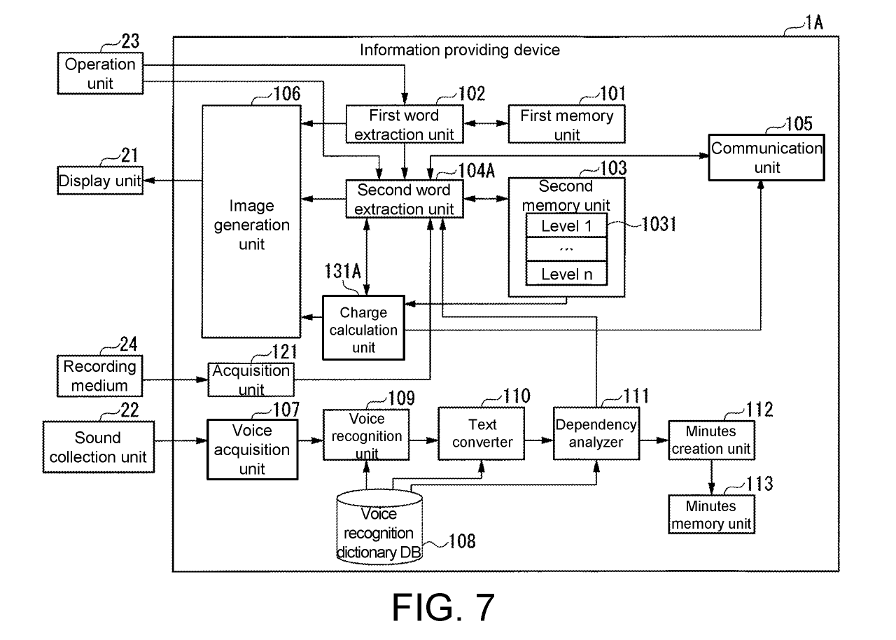

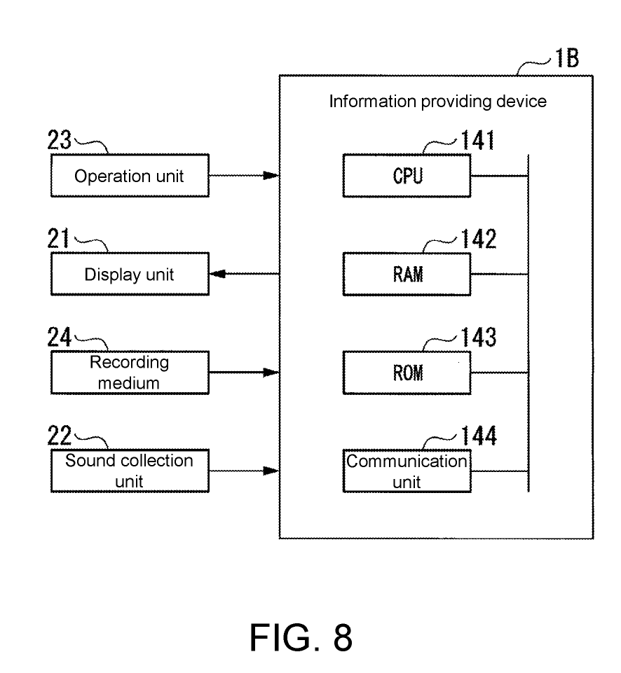

FIG. 7 is a block view showing a configuration example of an information providing device 1A in a first modification of the present embodiment. Functional parts having the same functions as those of the information providing device 1 are denoted by the same reference numerals, and explanation thereof is omitted. As shown in FIG. 7, the information providing device 1A includes the first memory unit 101, the first word extraction unit 102 (first word extraction unit), the second memory unit 103, a second word extraction unit 104A (word extraction unit), the communication unit 105, the image generation unit 106, the acquisition unit 121, a charge calculation unit 131A, a voice acquisition unit 107, a voice recognition dictionary database 108, a voice recognition unit 109, a text converter 110, a dependency analyzer 111, a minutes creation unit 112, and a minutes memory unit 113.

The display unit 21, a sound collection unit 22, and the operation unit 23 are connected to the information providing device 1A.

The sound collection unit 22 is a microphone. The sound collection unit 22 collects a voice signal and outputs the collected voice signal to the voice acquisition unit 107. In the case where there are a plurality of participants in a meeting, the sound collection unit 22 is used for each user.

The voice acquisition unit 107 acquires a voice signal output by the sound collection unit 22. The voice acquisition unit 107 converts an acquired analog voice signal into a digital signal and outputs the converted voice signal to the voice recognition unit 109.

The voice recognition dictionary database 108 is a database in which, for example, an acoustic model, a language model, a word dictionary and so on are stored. The acoustic model refers to a model based on a feature quantity of a sound; the language model refers to a model of information of words and their arrangement. In addition, the word dictionary refers to a dictionary based on a large amount of vocabulary, and is, for example, a large vocabulary word dictionary.

The voice recognition unit 109 acquires the voice signal output by the voice acquisition unit 107. The voice recognition unit 109 detects a voice signal of an utterance section from the voice signal output by the voice acquisition unit 107. For detection of the utterance section, for example, a voice signal having a predetermined threshold value or greater is detected as the utterance section. Moreover, the voice recognition unit 109 may detect the utterance section using other well-known methods. The voice recognition unit 109 performs voice recognition on the detected voice signal of the utterance section using a well-known method with reference to the voice recognition dictionary database 108. The voice recognition unit 109 performs voice recognition using, for example, a method disclosed in Japanese Laid-open No. 2015-64554, or the like. The voice recognition unit 109 outputs a recognized recognition result to the text converter 110. Moreover, the voice recognition unit 109 outputs the recognition result and the voice signal, for example, for each sentence or for each utterance section.

The text converter 110 converts the recognition result output by the voice recognition unit 109 into text with reference to the voice recognition dictionary database 108. The text converter 110 outputs the converted text information to the dependency analyzer 111. The text converter 110 may delete interjections such as “ah”, “uh”, “huh”, “well” and so on and then convert the recognition result into text.

The dependency analyzer 111 carries out morphological analysis and dependency analysis on the text information output by the text converter 110 with reference to the voice recognition dictionary database 108. For the dependency analysis, for example, support vector machines (SVMs) are used in a shift-reduce method, or a spanning tree method, or a stepwise application method of chunk identification. The dependency analyzer 111 outputs the text information output by the text converter 110 and a result of the dependency analysis to the minutes creation unit 112.

In addition, the dependency analyzer 111 removes interjections and so on based on the result of the dependency analysis and then extracts words. The dependency analyzer 111 outputs the extracted word to the second word extraction unit 104A.

The minutes creation unit 112 creates a minutes based on the text information output by the dependency analyzer 111 and stores minutes information of the created minutes in the minutes memory unit 113. The minutes creation unit 112 may store a voice signal related to the minutes information of the created minutes in the minutes memory unit 113.

The minutes memory unit 113 stores the minutes information of the minutes created by the minutes creation unit 112. Moreover, the minutes memory unit 113 may also store the voice signal of the meeting in association with the minutes information.

In addition to performing the processing performed by the second word extraction unit 104, the second word extraction unit 104A acquires the word output by the dependency analyzer 111. The second word extraction unit 104A outputs information indicating that the word has been acquired to the charge calculation unit 131A.

In addition to performing the processing performed by the charge calculation unit 131, the charge calculation unit 131A increases the view count by 1 when acquiring the information output by the second word extraction unit 104A that indicates that the word has been acquired.

As described above, according to the first modification, by performing voice recognition processing and so on a speaker's utterance, the recalling of a word when two words are presented can be measured and charged. The information providing device 1A may determine recalling of the word based on utterance of a predetermined phrase. The predetermined phrase refers to, for example, “really!” or “that's it!” and so on. These phrases are stored in the voice recognition dictionary database 108.

### <Second Modification>

The information providing device 1 in FIG. 1 or the information providing device 1A in FIG. 7 may comprise a central processing unit (CPU) and a random access memory (RAM) and a read only memory (ROM) and a communication unit. In this case, an operation performed by the information providing device 1 or the information providing device 1A may be realized by the CPU by an application.

FIG. 8 is a block view showing a configuration example of an information providing device 1B in a second modification of the present embodiment. The configuration shown in FIG. 8 is an example in which the information providing apparatus 1A is constituted by a CPU and so on. As shown in FIG. 8, the information providing device 1B includes a CPU 141, a RAM 142, a ROM 143 and a communication unit 144. The CPU 141, the RAM 142, the ROM 143 and the communication unit 144 are connected via a bus. The display unit 21, the sound collection unit 22, and the operation unit 23 are connected to the information providing device 1B. In addition, the information providing device 1B acquires information from the recording medium 24.

In this case, the ROM 143 may pre-store an application. Alternatively, the application may be provided by the recording medium 24. Alternatively, the application may be acquired by the communication unit 144 from a network.

In this case, the application may include the second word group which is classified by level and for which a charge is set.

An example of a charging method in the case where an operation performed by the information providing device 1 or the information providing device 1B is realized by the CPU 141 by an application in this way is explained. For example, in the information providing device 1, the view count may be counted when the user inputs the word by the operation unit 23, as the word is viewed (recalled).

In addition, in the information providing device 1A, the view count may be counted when the speaker utters the word, by performing voice recognition processing and so on the speaker's utterance.

In the second modification, the CPU 141 in the information providing device 1 or the information providing device 1B performs charging according to an operation condition of the application. The operation condition of the application refers to, for example, a condition in which it is detected that the operation unit 23 is operated and the word is input, or a condition in which the word can be recognized from the speaker's utterance, and so on. In such an operation condition, the CPU 141 measures the word as a recall, i.e., as the view count. Then, the CPU 141 counts the view count according to such an operation condition and calculates the usage charge based on the level used. The CPU 141 may calculate the usage charge based on the view time and the level. In this way, the CPU 141 calculates the usage charge based on the level and at least one of the view count and the view time and performs charging.

In the second modification, by executing the application by the CPU, the second word corresponding to the first word and of the selected level may be selected, and the first word and the second word may be presented.

Accordingly, according to the second modification, the application can be supplied or updated by the recording medium 24 (USB memory, memory card, optical disk, magnetic disk, magnetic tape, etc.). Also, accordingly, according to the second modification, the user can use the latest application. Also, accordingly, according to the second modification, the user can execute and utilize the application using a device (e.g., personal computer, tablet terminal, smartphone, etc.) they own.

### <Third Modification>

In the above embodiments, examples in which processing is performed by the application pre-stored in the information providing device 1 (or 1A or 1B) or the application provided by the recording medium 24 have been explained. However, the disclosure is not limited thereto. The above-mentioned application may be a World Wide Web (Web) application.

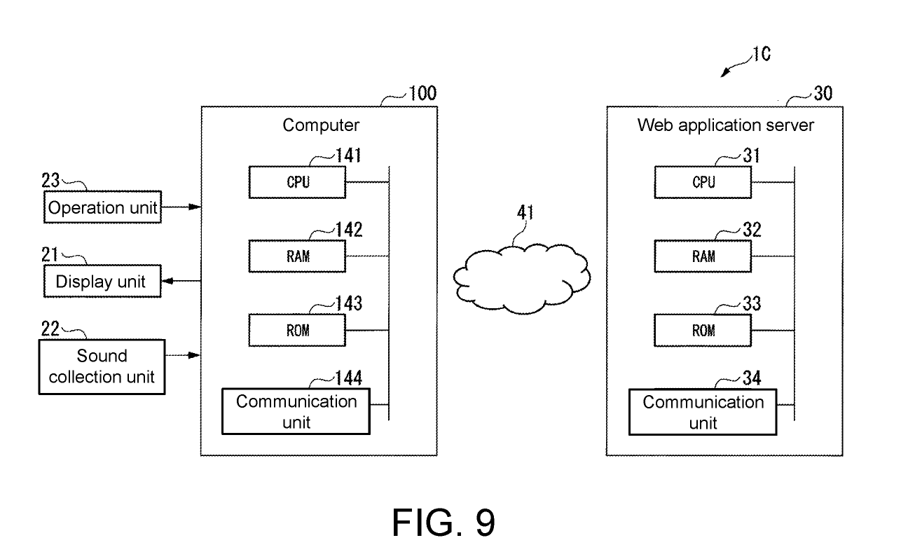

FIG. 9 is a block view showing a configuration example of an information providing system 1C in a third modification of the present embodiment.

As shown in FIG. 9, the information providing system 1C includes a computer 100 and a Web application server 30. The computer 100 is connected with the Web application server 30 via a network 41. The network 41 is, for example, the Internet.

The computer 100 includes the CPU 141, the RAM 142, the ROM 143 and the communication unit 144. The CPU 141, the RAM 142, the ROM 143 and the communication unit 144 are connected via a bus. The display unit 21, the sound collection unit 22, and the operation unit 23 are connected to the computer 100. The computer 100 may be a smartphone, a tablet terminal or the like.

The Web application server 30 includes a CPU 31, a RAM 32, a ROM 33 and a communication unit 34.

The computer 100 accesses a website providing an application according to a user's operation. The computer 100 displays the first word and the second word on the display unit 21 by the application provided by the Web application server 30. The second word is a word selected by the Web application server 30. The second word may also be a word extracted from the second word group of a level selected by the user. Moreover, the application may be a Web application operating in a browser and based on Java (registered trademark) or Web 4 and so on.

In the case where the application is executed by the Web application server 30, the usage charge may be calculated by the computer 100 and notified to the Web application server 30, or may be calculated by measurement by the Web application server 30. The Web application server 30 may calculate the usage charge based on, for example, the view count or the view time and the level. Then, the CPU 141 or the Web application server 30 calculates the usage charge based on the level and at least one of the view count and the view time and performs charging.

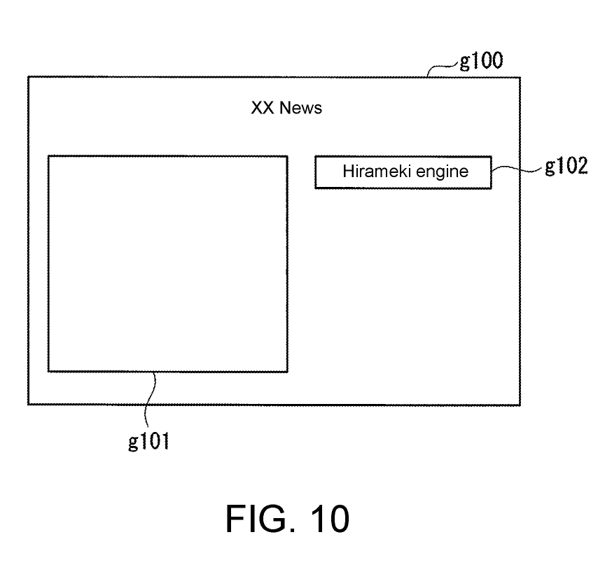

FIG. 10 illustrates an example of a Web application providing method in the third modification. A sign g100 indicates an image displayed on the display unit 21 and an image displayed when the computer 100 accesses a website of “XX News”.

The image of the sign g100 includes an article image g101 and a banner button image g102. The user selects the banner button image g102 by operating the operation unit 23. In the case where the banner button image g102 is selected, the computer 100 and the Web application server 30 are connected via the network 41, and the computer 100 executes the application provided by the Web application server 30. As a result, the image g20 shown in FIG. 4, for example, is displayed on the display unit 21. The first word is input by the user operating the operation unit 23.

As described above, according to the third modification, by the application provided through the Web, the user can use a service named “Hirameki engine” according to presentation of two words using the browser. As a result, the user can also use this service from a smartphone or a tablet terminal or the like.

Also, according to the third modification, since there is no need for the computer 100 to store the second word group or the application, execution is possible even if memory capacity of the computer 100 is small.

A program for realizing all or part of the functions of the information providing device 1 (or 1A or 1B) in the disclosure may be recorded on a computer-readable recording medium, and all or part of the processing performed by the information providing device 1 (or 1A or 1B) may be performed by having a computer system read and execute the program recorded on the recording medium. The “computer system” mentioned here includes an OS or hardware such as peripheral devices. In addition, the “computer system” also includes a WWW system having a homepage providing environment (or display environment). The “computer-readable recording medium” refers to a memory device, such as a portable medium such as a flexible disk, a magneto-optical disk, a ROM and a CD-ROM, or a hard disk built in the computer system, and so on. Furthermore, the “computer-readable recording medium” also includes those holding a program for a fixed time, such as a volatile memory (RAM) in the computer system serving as a server or a client in the case where the program is transmitted via a network such as the Internet or a communication line such as a telephone line.

The above program may be transmitted from a computer system in which the program is stored in the memory device or the like to another computer system via a transmission medium or by a transmission wave in the transmission medium. Herein, the “transmission medium” that transmits the program refers to a medium having a function of transmitting information, like a network (communication network) such as the Internet or a communication line such as a telephone line. The above program may be for realizing part of the aforementioned functions. Furthermore, the above program may be a so-called differential file (differential program) capable of realizing the aforementioned functions by combination with a program already recorded in the computer system.

Although the embodiments for carrying out the disclosure have been explained above by way of embodiments, the disclosure is not limited to these embodiments at all, and various modifications and replacements may be made without deviating from the gist of the disclosure.

What is claimed is:

1. An information providing device presenting a first word and a second word extracted from a second word group, the information providing device comprising:
a second memory unit storing the second word group comprising a plurality of words corresponding to the first word, and storing the second word group by level of the words; and
a word extraction unit extracting a word corresponding to the first word from the second word group as the second word, wherein
the first word is a discussion theme; and
a charging system is different for each level in the second word group.

2. The information providing device according to claim 1, wherein the level of the words is a number of times the words have been extracted by the word extraction unit in the past.

3. The information providing device according to claim 1, wherein the second word is preset by a predetermined professional.

4. The information providing device according to claim 1, wherein the information providing device is operated by an application, and performs charging based on the level and according to an operation condition of the application.

5. The information providing device according to claim 4, wherein the operation condition comprises at least one of view count and view time.

6. The information providing device according to claim 4, wherein the application is operated on the Web.

7. The information providing device according to claim 4, wherein the application is provided by a recording medium.

8. The information providing device according to claim 1, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.

9. An information providing method in an information providing device, wherein the information providing device has a second memory unit that stores a second word group comprising a plurality of words corresponding to a first word, a charging system being different for each level of the words in the second word group, and that stores the second word group by level of the words, the information providing method comprising:
a step of setting the first word as a discussion theme by the information providing device;
a step of presenting the level and setting a second word to a level selected from among the presented level by the information providing device;
a word extracting step of extracting a word corresponding to the first word from the second word group as the second word by the information providing device;
a presentation step of presenting the first word and the second word by the information providing device; and
a charging step of calculating a usage charge based on the level and at least one of view count and view time of the presentation and performing charging by the information providing device.

10. A non-transitory recording medium storing a program for a computer of an information providing device, wherein the information providing device has a second memory unit that stores a second word group comprising a plurality of words corresponding to a first word, an charging system being different for each level of the words in the second word group, and that stores the second word group by level of the words, the program causing the computer to execute:
a step of setting the first word as a discussion theme;
a step of presenting the level and setting a second word to a level selected from among the presented level;
a word extracting step of extracting a word corresponding to the first word from the second word group as the second word;
a presentation step of presenting the first word and the second word; and
a charging step of calculating a usage charge based on the level and at least one of view count and view time of the presentation and performing charging.

11. The information providing device according to claim 2, wherein the second word is preset by a predetermined professional.

12. The information providing device according to claim 2, wherein the information providing device is operated by an application, and performs charging based on the level and according to an operation condition of the application.

13. The information providing device according to claim 3, wherein the information providing device is operated by an application, and performs charging based on the level and according to an operation condition of the application.

14. The information providing device according to claim 5, wherein the application is operated on the Web.

15. The information providing device according to claim 5, wherein the application is provided by a recording medium.

16. The information providing device according to claim 2, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.

17. The information providing device according to claim 3, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.

18. The information providing device according to claim 4, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.

19. The information providing device according to claim 5, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.

20. The information providing device according to claim 6, further comprising:
a first memory unit storing a first word group comprising at least one word and storing a word group of a discussion theme in the first word group; and
a first word extraction unit extracting a word from the first word group as the first word, wherein
the information providing device presents the level before extracting the second word and sets a second word to a level selected from among the presented level, and
the information providing device presents the first word extracted by the first word extraction unit, and the second word extracted from among the second word group of the set level by the word extraction unit.
